(19) United States
(12) Patent Application Publication
(10) Pub. No.: US 2015/0363687 A1
(43) Pub. Date: Dec. 17, 2015

(54) MANAGING SOFTWARE BUNDLING USING AN ARTIFICIAL NEURAL NETWORK

(71) Applicant: International Business Machines Corporation, Armonk, NY (US)

(72) Inventors: Pawel Gocek, Lodz (PL); Piotr Kania, Krakow (PL); Michal Paluch, Krakow (PL); Tomasz Stopa, Krakow (PL)

(21) Appl. No.: 14/303,802

(22) Filed: Jun. 13, 2014

(51) Int. Cl. G06N 3/02; G06N 3/08

(52) U.S. Cl. CPC G06N 3/02; G06N 3/08

(57) ABSTRACT

An artificial neural network is used to manage software bundling. During a training phase, the artificial neural network is trained using previously bundled software components having known values for identification attributes and known software bundle asociations. Once trained, the artifical neural network can be used to identify the proper software bundles for newly discovered sofware components. In this process, a newly discovered software component having known values for the identification attributes is identified. An input vector is derived from the known values. The input vector is loaded into input neurons of the artificial neural network. A yielded output vector is then obtained from an output neuron of the artificial neural network. Based on the composition of the output vector, the software bundle associated with this newly discovered software component is determined.

### BACKGROUND

The present disclosure relates to software bundling, and more specifically, to managing software bundling using an artificial neural network.

With the advent of complex software licensing models, it has become increasingly important for entities to be able to monitor the use of software by their own agents. In some instances this monitoring is required according to licensing agreements with the applicable software providers. In other instances, this monitoring may not be strictly required, but may help to ensure license compliance and efficient resource allocation.

### SUMMARY

According to embodiments of the present disclosure, aspects of the disclosure may include a method, a system, and a computer program product. The method, system, and computer program product may include identifying a software component having a first value for a first identification attribute and a second value for a second identification attribute. An input vector may be derived from the first value and the second value. The input vector may be loaded into an at least one input neuron of an artificial neural network. A yielded output vector may then be obtained from an at least one output neuron of the artificial neural network.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a high-level diagram of a computer network with software components dispersed over the individual computers of the network and software bundling information about these software components organized in a bundling database, in accordance with embodiments of the present disclosure.

FIG. 2 illustrates a flowchart of a method for acquiring training data that may be used to train an artificial neural network to determine software bundling information for discovered software components, in accordance with embodiments of the present disclosure.

FIG. 3 illustrates a detailed block diagram showing an instance of training an artificial neural networking using data derived from a software component having known values of several identification attributes and a known association with a software bundle, in accordance with embodiments of the present disclosure.

FIG. 4 illustrates a flowchart of a method for training an artificial neural network using previously stored training data, in accordance with embodiments of the present disclosure.

FIG. 5 illustrates a diagram showing the entering of an input vector generated from training data derived from a specific, previously-bundled software component into the input neurons of an artificial neural network, and the yielding, from the output neuron of that artificial neural network, of an output vector with a dimension corresponding to a specific software bundle, in accordance with embodiments of the present disclosure.

FIG. 6 illustrates a diagram showing the use of an artificial neural network in determining the software bundle associated with an unbundled software component discovered on a remote device of an applicable network, in accordance with embodiments of the present disclosure.

FIG. 7 illustrates a flowchart of a method for using a trained artificial neural network in determining the software bundle associated with a newly-discovered, unbundled software component, in accordance with embodiments of the present disclosure.

FIG. 8 illustrates a block diagram showing the modules of a neural network device, in accordance with embodiments of the present disclosure.

FIG. 9 illustrates a block diagram showing the architecture of an example computer usable with methods employed in embodiments of the invention, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to managing software bundling using artificial neural networks. More specifically, aspects of the disclosure relate to identifying software components having known software bundle associations and known identification attributes, generating test input and output vectors based on this known information, and using these test vectors to train artificial neural networks. Additionally, aspects of the disclosure relate to using trained artificial neural networks to determine software bundles associated with software components lacking known software bundle associations. While the present disclosure is not necessarily limited to such applications, various aspects of the disclosure may be appreciated through a discussion of various examples using this context.

In some embodiments, the efficacy of an entity's software licensing management scheme may be improved in instances where the entity's software asset administrator has detailed knowledge of what licensed software is deployed on the entity's network, where this software is deployed on the network, and the terms and conditions of the various licenses that govern the use of this software. One potentially difficult aspect of building and maintaining such a management scheme, however, may be obtaining knowledge about software deployment in the first place. This is because even after the location of an individual software component has been determined, it may still be quite difficult to determine the licensing terms (e.g., price terms, usage limitations, etc.) that govern that specific software component. This is true because the licensing terms governing a given software component may depend on the software offering with which the component is associated (i.e., the software bundle under which the component is licensed). For example, an entity may be entitled to use a specific database software component for free if it is bundled with one offering. However, if it is bundled with another offering, the entity may have to pay for it.

As used herein, a component or software component may refer to a unit of software that can be detected as installed or running on a computer system independently of other software items. Each component may or may not be a part of a software product. In some embodiments, a component may be separately identified, but not individually licensed.

Further, as used herein, an offering, software offering, bundle, or software bundle may refer to a packaged collection of components. A single license or a single set of licensing terms may cover all components of a bundled offering. In some embodiments, an offering may be offered for promotional purposes.

The structure of these items may be hierarchical (e.g., individual components may be bundled). In some embodiments, many components may be assigned to one bundle, and identical components may be assigned to many other bundles. Similarly, many components may be assigned to one bundle, and identical components may be shared between many bundles. In some embodiments, all or most possible applicable software bundles may be known (or knowable) by a software asset administrator; for example, the list of possible bundles may be included in a catalog provided by the entity making the software offerings.

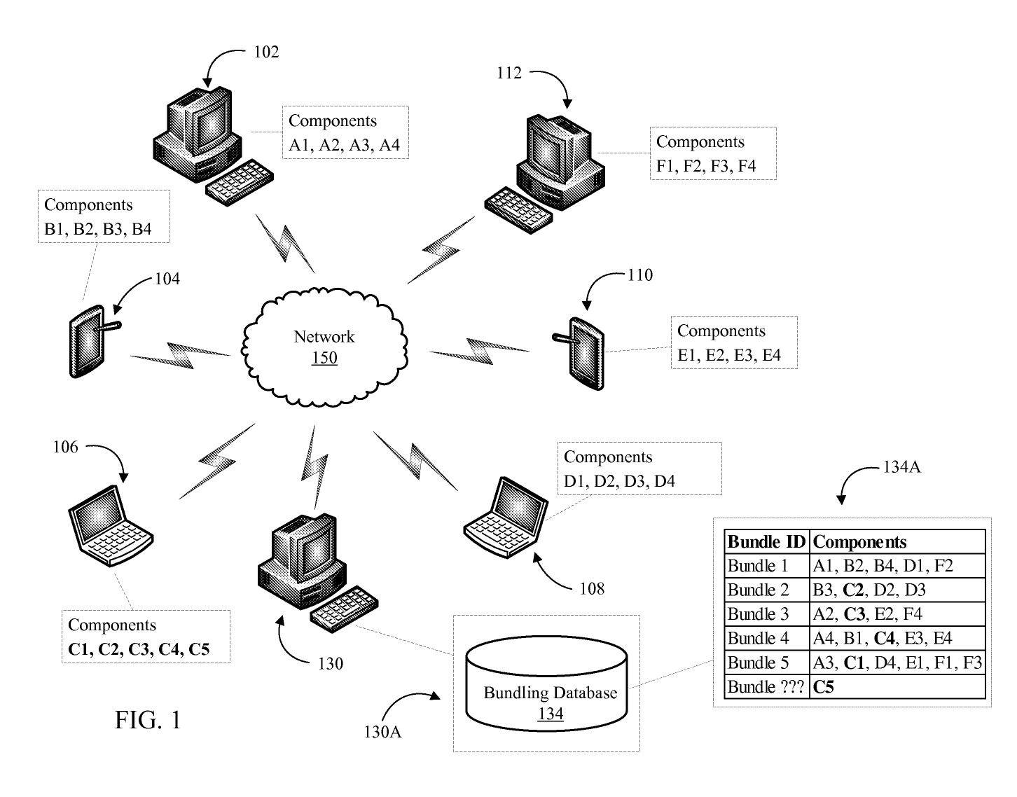

Turning now to the figures, FIG. 1 illustrates a high-level diagram of a computer network 150 with software components A1-F4 dispersed over computers 102, 104, 106, 108, 110, and 112 of the network 150. Software bundling information about these software components may be organized in a bundling database 134, in accordance with embodiments of the present disclosure. As shown in block 130A, the bundling database 134 may be stored on computer 130, which may itself be connected to network 150. It is contemplated that computers 102-112 and 130 may be any relevant computer system or combination of computer systems including, for example, servers, desktops, laptops, mobile phones, smart phones, tablets, personal or enterprise digital assistants, and the like. Further, the seven computers 102-112 and 130 of FIG. 1 are shown for illustrative purposes only; it is contemplated that dozens, hundreds, or even thousands of computers may be used in some embodiments. Likewise, consistent with some embodiments, the number of components and number of possible bundles may also number in the hundreds or thousands.

In some embodiments, the network 150 may be implemented by any number of any suitable communications media (e.g., wide area network (WAN), local area network (LAN), Internet, Intranet, etc.). Alternatively, the computers of network 150 may be local to each other, and communicate via any appropriate local communication medium (e.g., local area network (LAN), hardwire, wireless link, Intranet, etc.). In some embodiments, the network 150 may be implemented within a cloud computing environment, or using one or more cloud computing services. A cloud computing environment may include a network-based, distributed data processing system that provides one or more cloud computing services.

In some embodiments, network 150 may refer to only or mostly those computers that are owned or controlled by a single entity or the agents for whom that entity is responsible (e.g., employees, independent contractors, etc.). In some embodiments, the scope of network 150 may effectively be defined by that environment (e.g., group of computer systems) over which an applicable entity has bundling management or software licensing responsibilities.

As shown in block 134A, the bundling database 134 may store software bundling information about the applicable components dispersed (i.e., deployed on different computers) throughout the network 150. Additionally, the bundles with which the components are associated may also be known and the information about the relationships between software bundles and components may also be stored by the software asset administrator in bundling database 134. For example, as shown in the pictured embodiment, the bundling database 134 may include bundling information about twenty-four components (A1-F4) organized into five bundles (Bundle 1-Bundle 5) and a twenty-fifth component (C5) for which the appropriate bundle has not yet been determined (i.e., it may not yet be known which license governs the use of that particular component). In some embodiments, the components of any given computer within the applicable network may be part of different bundles. For example, in the pictured embodiment, the components of computer 106 (i.e., C1, C2, C3, C4, and C5) may belong to Bundles 5, 2, 3, 4, and an unknown bundle, respectively. Likewise, in some embodiments, the components of any given bundle may be located on different computers within the applicable network. For example, in the pictured in embodiment, Bundle 1 includes five components A1, B2, B4, D1, and F2 which are installed on computers 102, 104, 104, 108, and 112, respectively. Further, in some embodiments, it is contemplated that two or more different components on the same network or even on the same computer within a network may be of the same type or identical (e.g., A1, B3, and C4 may all be the same type of database program, B1 and D4 may be the same type of word processing program, etc.) Using the bundling information provided in block 134A, a software asset administrator may be equipped to make well-informed decisions about software management.

In accordance with embodiments of the present disclosure, a software asset administrator may obtain software bundling information about an unbundled software component (e.g., a newly discovered software component for which a bundle association is unknown, such as component C5 of FIG. 1) by using an artificial neural network. As used herein, and as discussed in more detail below, an artificial neural network may refer to a statistical model incorporating numerical parameters that are adjusted through a learning algorithm, such that the model is capable of approximating functions of its input values. In some embodiments, an artificial neural network may be a computational tool that is capable of deriving functions based on patterns found in learned examples derived from training data loaded into the neural network.

It is contemplated that a wide variety of different types of artificial neural networks could be suitable for use in some embodiments of the present invention. For example, in some embodiments, supervised learning may be used to train an artificial neural network; in other embodiments, unsupervised or reinforcement learning may occur.

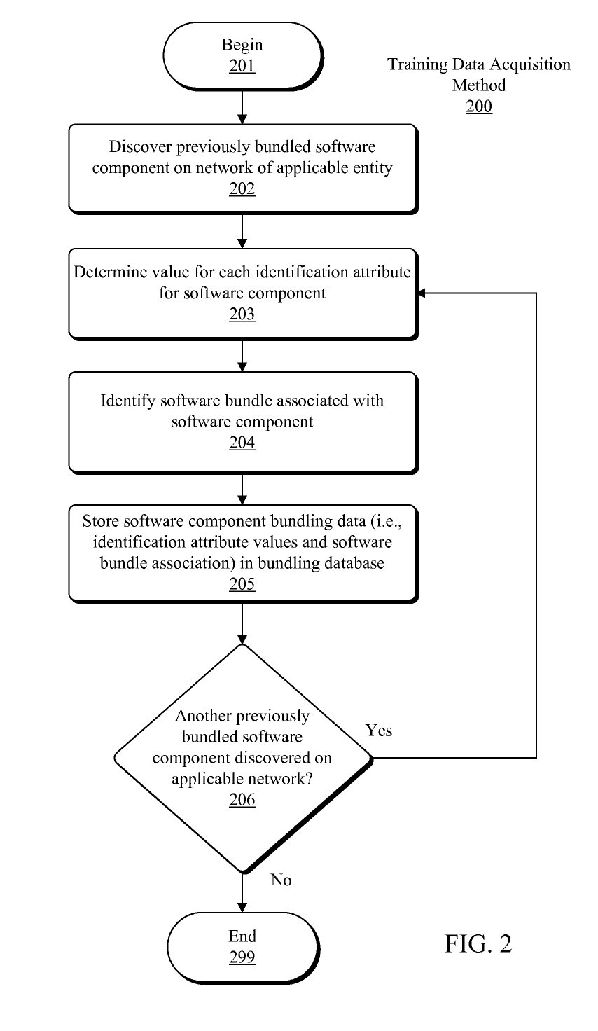

In some embodiments, in order for a neural network to be used with a high degree of confidence it may first need to be adjusted (i.e., taught or trained) through a training phase. Prior to beginning a training phase, however, training data may first need to be collected and organized. FIG. 2 illustrates a flowchart of a method 200 for acquiring training data that may be used to train an artificial neural network to determine software bundling information for discovered software components, in accordance with embodiments of the present disclosure. The method begins at block 201. At block 202, a previously-bundled software component (i.e., a component for which the corresponding software bundle has been predetermined) may be discovered on the network of the applicable entity. The software component may be discovered using any appropriate means, for example, through the use of network scanning and detection software.

Next, per 203, values for a number of identification attributes associated with the discovered component may be determined. An identification attribute may refer to any predetermined category of information that may be useful in determining relationships between software components and software bundles. In other words, identification attributes of software components may include variables that may be predictive in the context of software bundling. Example identification attributes may include installation path, operating system, network domain name, start date, modification date (e.g., the last date the installation path was modified), and user Internet Protocol (IP) address (i.e., the IP address of the computer on which the component is installed). In some embodiments, each software component may have a separate value for a given identification attribute or two or more software components on the same network may share values for one or more identification attributes. Further, in some embodiments, not every previously-bundled component may have a known value for every identification attribute. Moreover, in some embodiments, not every identification attribute may be used in identifying software bundles. This may occur for example, when a software asset administrator determines that a specific identification attribute has low predictive power in identifying software bundles.

Continuing method 200 at block 204, the software bundle associated with the previously-bundled software component may also be identified. This association may have been previously determined using any applicable means including, for example, through manual bundling by a software administrator or through the use of an automated bundling mechanism employing a number of rigid bundling rules. Per block 205, the bundling data for the software component (i.e., the identification attribute values and software offering association) may be stored in a bundling database. Such a database may include, for example, database 134 of FIG. 1.

Per block 206, a determination may be made as to whether other previously-bundled software components have been discovered on the applicable network. If another component is discovered, then the process (i.e., blocks 203-205) may be performed on that particular component. Once there are no more remaining components to be analyzed, the method may, per block 299, end.

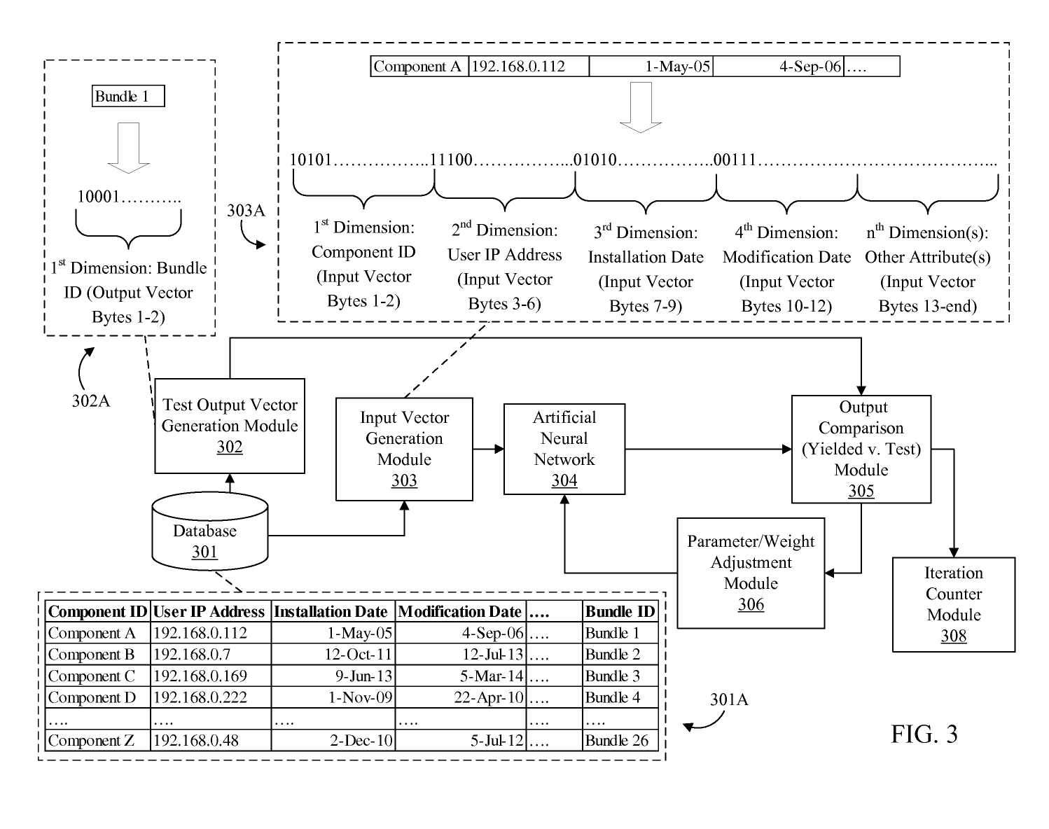

Once sufficient training data has been obtained, training of an applicable artificial neural network may begin. FIG. 3 illustrates a detailed block diagram showing an instance of training an artificial neural network using data derived from a software component having known values of several identification attributes and a known association with a software bundle, in accordance with embodiments of the present disclosure. In this embodiment, training data shown in chart 301A is stored in database 301. This data may be obtained, for example, by using training data acquisition method 200 of FIG. 2. This training data may include, for each component, a component name or other identifier (e.g., Component A, Component B, etc.), a value for several identification attributes (e.g., user IP address, installation date, modification date, etc.) and a name or other identifier of the bundle with which each previously-bundled software component is associated (e.g., Bundle 1, Bundle 2, etc.).

In some embodiments of the invention, vectors having one or more dimensions may be used to load data into or obtain data from artificial neural networks. As used herein, a vector may refer to any suitable representation of applicable data that is capable of being processed by an artificial neural network. In some embodiments, vectors may include alphanumeric or binary strings that represent specific values for variables (e.g., identifiers, attributes, etc.). Each specific value may be represented in a single dimension (i.e., a specific portion of a string corresponding to a specific variable). This may result in a one to one relationship between applicable values and dimensions, such that the number of dimensions that a vector has may be indicative of the number of variables that it represents (e.g., a three-dimensional vector may have three values corresponding to three variables).

In order to perform a training instance of the artificial neural network, the training data may be used to generate a test output vector, via test output vector generation module 302, and a corresponding test input vector, via input vector generation module 303. In the shown embodiment, training data related to Component A is used in a training instance for training artificial neural network 304. As shown in block 302A, a test output vector may be generated by converting the bundle identifier (e.g., Bundle 1) into a single-dimensional test output vector that may be two bytes (i.e., sixteen bits) in length, with the bytes together serving to represent the applicable bundle ID.

Similarly, as shown in block 303A, a test input vector may be generated via input generation module 303 by converting each of the component id (e.g., Component A) and the identification attribute values (e.g., 192.168.0.112, May 1, 2005 and Sep. 4, 2006) into separate dimensions of the test input vector. Each dimension may have a different length. The length of dimensions associated with each attribute may vary depending on the number of possible or probable different values there may be for that attribute. For example, a component ID may require fewer bytes for representation than a user IP address because the number of possible component ID's may be significantly less than the number of possible applicable user IP addresses.

In some embodiments, in order to maintain consistency in vector formatting (i.e., to standardize the manner in which data is represented to an artificial neural network), vector dimensions may be normalized. In some embodiments, this normalization may involve representing non-numeric values using ASCII numbers. Further, numeric values may be normalized, for example, by using modulo 128, thereby effectively allowing each number to be represented by an ASCII character. This normalization may further involve truncating vector dimension lengths to a predetermined number of characters (e.g., for an output vector dimension with two-bytes the number of characters may be truncated to sixteen). On the other hand, vector dimension lengths that are too short may be normalized by adding enough characters to reach the standardized length (e.g., by filling in “0's” for short vectors dimensions to make them reach the common length). By using a normalization procedure, the length of every dimension associated with values for a particular attribute may be standardized (e.g., the dimension associated with the user IP address attribute may consistently be four bytes in length and, moreover, may consistently be represented by bytes three through six of each input vector). In addition, for previously-bundled software components for which one or more values for attributes are not known, a dimension corresponding to that attribute may still, in some instances, be generated, for example, by inserting all “0's” in the dimension corresponding to the unknown attribute value.

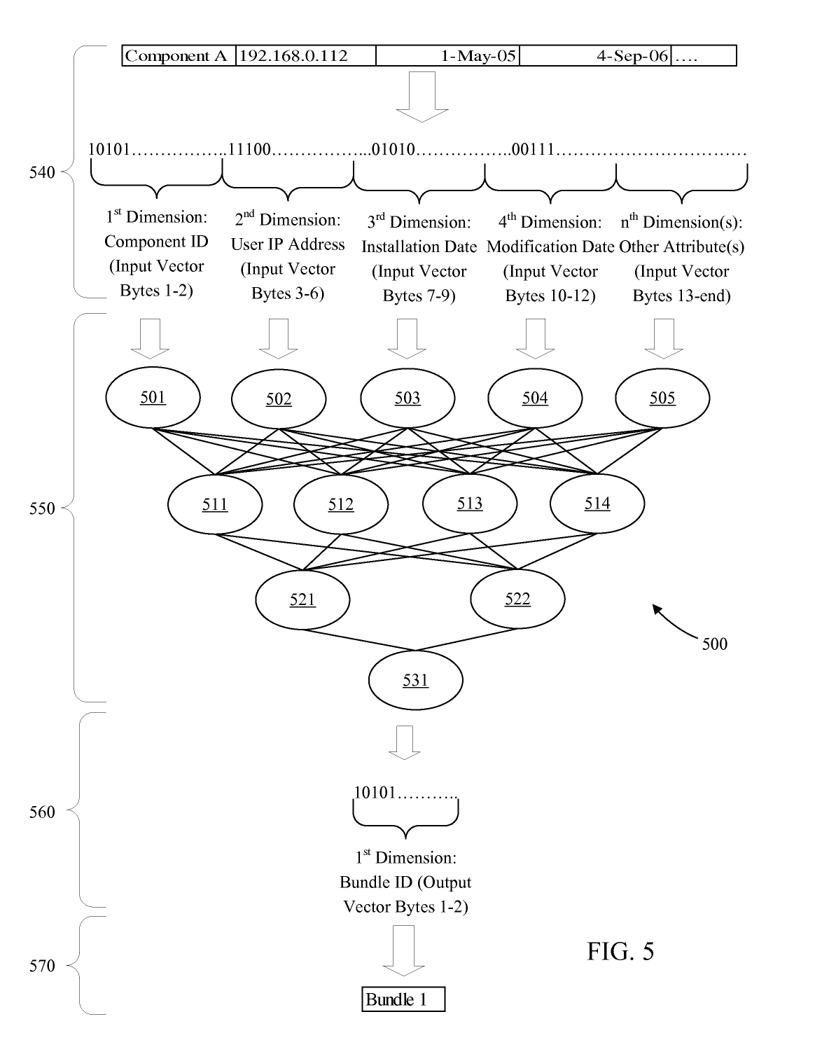

Once a test input vector is generated by input vector generation module 303, it may be loaded (i.e., entered) into the input neurons of the artificial neural network 304. The details of an example use of an artificial neural network are discussed in more detail below and shown in FIG. 5. The artificial neural network 304 may then yield an output vector from its output neuron. This yielded output vector may then be compared with the previously generated test output vector, via the output comparison module 305. In a perfectly trained artificial neural network, the comparison may reveal that the yielded output vector and the test output vector are the same (i.e., the artificial neural network may correctly determine the bundle associated with the previously-bundled component used to generate the test input vector in that particular training instance). In some training instances, the yielded output vector may be significantly different from the test output vector. This may occur, for example, early in a training phase, where an artificial neural network has not had much opportunity to adapt to training data.

The result of the comparison between the yielded output vector and the test output vector may then be used by parameter/weight adjustment module 306 to determine how the parameters of the artificial neural network should be modified, so as to produce more accurate resulting outputs. The parameter/weight adjustment module 306 may then adjust the artificial neural network accordingly, which may then result in more accurate future bundle determinations. In some embodiments, this comparing and adjusting may take the form of back propagation. In some embodiments, an iteration counter module 308 may be used to keep track of how many times the neural network has been trained and the training data used for particular training instances.

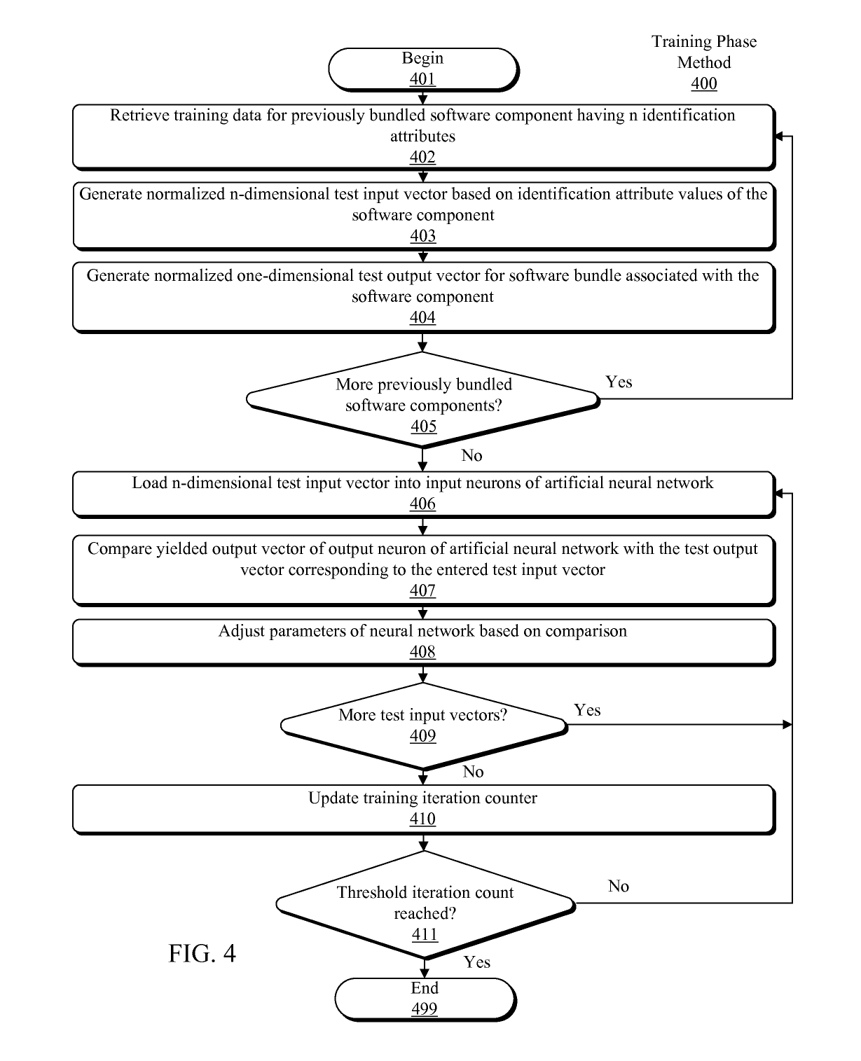

The training process described above may be systematized and repeated many times during the course of a training phase. FIG. 4, for example, illustrates a flowchart of a method 400 for training an artificial neural network using previously stored training data, in accordance with embodiments of the present disclosure. Training phase method 400 may begin at block 401. Per 402, a computer performing the method may retrieve training data for a previously-bundled software component having known values for n identification attributes. In this example, n may refer to any suitable number of identification attributes that may be helpful in training an artificial neural network. The number and type of identification attributes used may vary depending on several factors, including, for example, the types of data available.

Per block 403, the computer may generate a normalized n-dimensional test input vector based on the identification attribute values of the selected software component. Per block 404, a normalized one-dimensional test output vector for the software bundle associated with the selected software component may also be generated. Next, per 405, a determination may be made as to whether training data on more previously-bundled software components is available. If so, then the process corresponding to 402-404 may be repeated for each such software component, resulting in what may be a large group of test input and output vectors. In some embodiments, the group of vectors may be very few input/output vector pairs or as many as thousands or more of input/output vector pairs, depending on the amount of training data available.

Per block 406, an n-dimensional test input vector may be entered into the input neurons of an artificial neural network. Next, per block 407, an output vector may be yielded by an output neuron of the artificial neural network and may be compared with the test output vector corresponding to the entered test input vector. Per 408, the parameters of the neural network may then be adjusted (or, more specifically, readjusted in situations where the parameters were already adjusted previously) based on the comparison.

Per 409, a determination may be made as to whether there are additional test input vectors available. If so, then the process of blocks 406-408 may be repeated for each test input vector. Once each test input vector has been loaded into the artificial neural network, a training iteration counter may be updated per block 410. Each iteration counted by the iteration counter may correspond to one training instance for every available input vector (i.e., one run through all of the available training data). Next, a determination may be made, per 411, as to whether a threshold iteration count has been reached. In some embodiments, the threshold count may correspond to the minimum number of training iterations that may be necessary to adequately train an artificial neural network. This threshold may be set by a user or otherwise. It may depend on a number of factors including the amount of training data available and the amount of computing power available. If the threshold has not been reached, then the process of blocks 406-410 may be repeated (i.e., the artificial neural network may undergo another teaching iteration). Once the threshold is achieved, the training phase method 400 may, per block 499, be completed.

In some embodiments, the training phase may not rely on a threshold count to determine when training should be completed, but rather may rely on the achievement of some preset threshold level of confidence. For example, once a confidence rate of ninety percent is achieved (i.e., the neural network is likely to accurately predict bundle associations in nine out of ten cases), the training may be considered completed. In some embodiments, training may be continuously or periodically performed throughout the life-cycle of the artificial neural network. Additional training may be triggered, for example, when additional training data becomes available or when the artificial neural network's accuracy rate drops below a certain threshold.

In some embodiments, it is contemplated that all or a portion of the training phase for a given artificial neural network may occur on a different computer network from the one on which the artificial neural network may ultimately be used or intended for use. Similarly, training data derived from a different computer network may also be used in training This may occur, for example, in instances where the target computer network does not have enough previously-bundled software components to generate sufficient training data to fully train the artificial neural network. It may also occur, for example, where time may be of the essence and using an artificial neural network pre-trained on a network that is similar in one or more respects to the target network may serve to shorten the training time. Further, in some embodiments, previously identified heuristics or algorithms that relate to software bundling may be used in association with, or in the training of, an artificial neural network.

FIG. 5 illustrates a diagram showing the entering of an input vector generated from training data derived from a specific, previously-bundled software component into the input neurons of an artificial neural network 500 and the yielding, from the output neuron of that artificial neural network 500, of an output vector with a dimension corresponding to a specific software bundle, in accordance with embodiments of the present disclosure. In this example, the input and output data correspond to the training data related to Component A discussed above in relation to FIG. 3. It is contemplated, however, that the same basic use of the artificial neural network may be made using other data or during the execution phase of an artificial neural network.

Per bracket 540, training data may be used to generate an n-dimensional input vector. Next, per 550, the input vector may be entered into the input neurons 501-505 of artificial neural network 500. As shown, each dimension of the input vector may be input into a different input neuron of neurons 501, 502, 503, 504, and 505. In this example, input neuron 505 may represent multiple neurons with each neuron corresponding to an additional attribute value included on the end of the input vector.

Next, per bracket 560, an output vector may be yielded by the output neuron 531 of the artificial neural network 500. The yielded output vector may then, per 570, be used to determine the bundle associated with the applicable software component. For example, in this instance, Bundle 1 may be correctly identified as being associated with Component A.

The artificial neural network 500 is depicted as a four-layer, feedforward artificial neural network with an input layer having five neurons (501, 502, 503, 504, and 505), a first hidden layer having four neurons (511, 512, 513, and 514), a second hidden layer having two neurons (521 and 522), and an output layer having a single neuron (531). Many other types of artificial neural networks are contemplated with many different variations. For example, the number of layers or number of neurons in each layer may be varied. Further, an applicable artificial neural network may be a recurrent neural network (rather than feedforward).

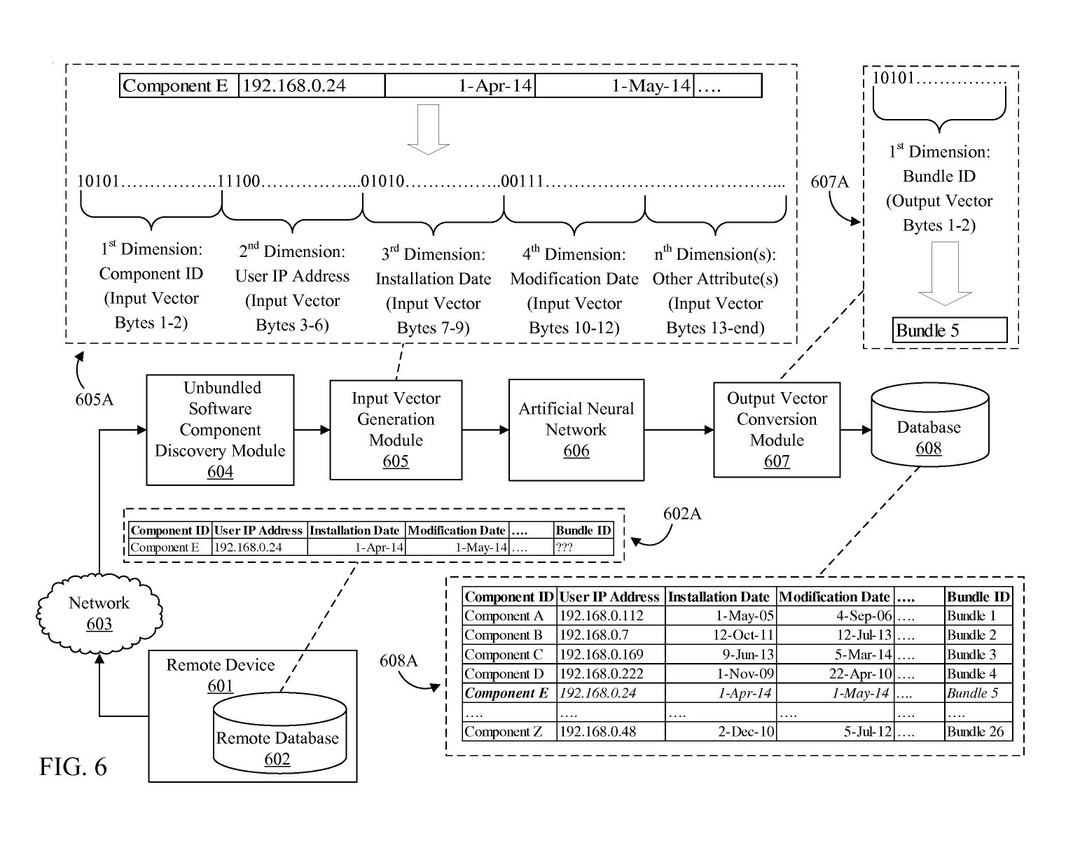

Once a neural network has been trained, it may be used to determine bundling information for newly-discovered software components. FIG. 6 illustrates a diagram showing the use of an artificial neural network in determining the software bundle associated with an unbundled software component discovered on a remote device of an applicable network, in accordance with embodiments of the present disclosure. In this example, a new software component (e.g., Component E) may be installed on remote device 601, which may itself be on the same system or the same network as the artificial neural network. The component may have the attributes shown in table 602A as recorded in remote database 602 of the remote device 601. The new component may be discovered over network 603 in a scan of the network performed by unbundled component discovery module 604. In order to determine the proper bundle associated with the unbundled software component, an execution input vector may be generated via input vector generation module 605. As shown in 605A, the execution input vector may have a number of dimensions corresponding to the number of applicable identification attributes. Next, the execution input vector may be entered into artificial neural network 606. The artificial neural network may have been previously trained, for example, by using training phase method 400 of FIG. 4. The output neuron of artificial neural network 606 may yield an output vector that may be converted by output vector conversion module 607 into the name or identifier of the appropriate bundle. As shown in 607A, in this example, Component E is determined to be associated with Bundle 5. This information may be stored in a central database 608, for example, in the form of table 608A.

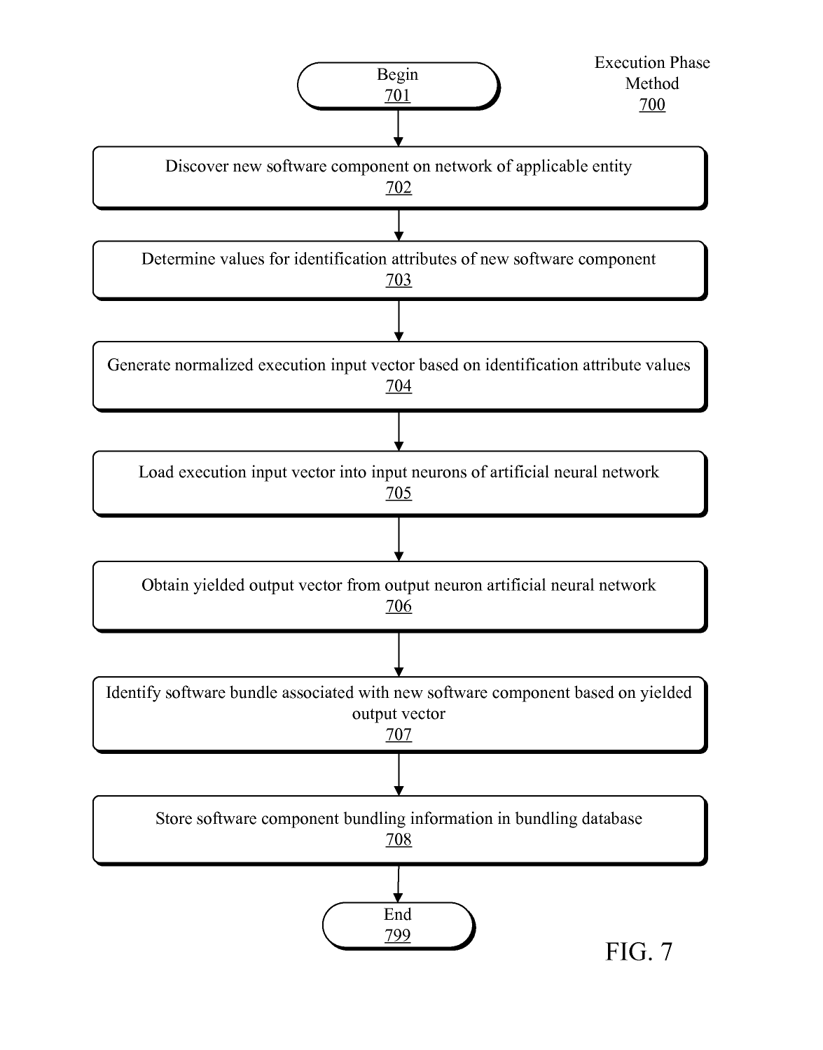

The process outlined in the blocks of FIG. 6 may, in some embodiments, take the form of a systematized method. FIG. 7 illustrates a flowchart of a method 700 for using a trained artificial neural network in determining the software bundle associated with a newly-discovered, unbundled software component, in accordance with embodiments of the present disclosure. The method begins per block 701. An applicable computer discovers, per 702, a new software component on the network of an applicable entity. The software component may have been recently downloaded onto a remote computer of the network or may have been recently modified. Per 703, values may be determined for the identification attributes of the new software component. Per 704, a normalized execution input vector may be generated based on the identification attribute values. The execution input vector may be loaded, per 705, into the input neurons of the applicable artificial neural network. Per 706, a yielded output vector may be obtained from an output neuron of the artificial neural network, and, per 707, the identity of the software bundle associated with the new software component may be determined based on the yielded output vector. Finally, per 708, the software component bundling information may be stored in a bundling database for future use, for example, by a software asset administrator attempting to calculate appropriate license fees due from the entity. The method may end per block 799.

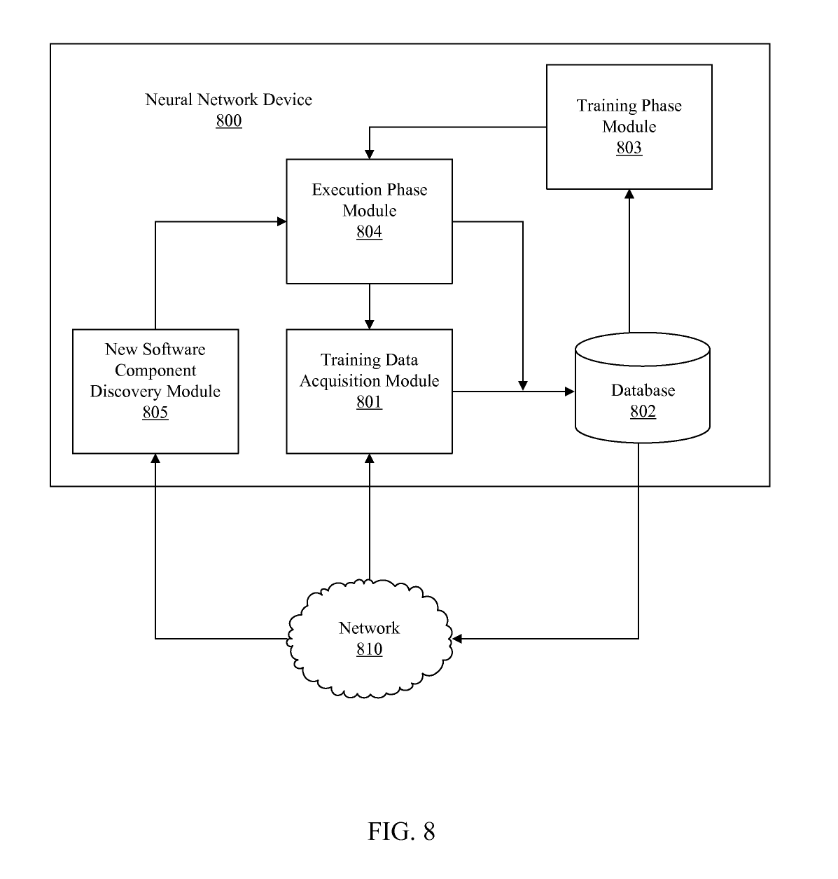

FIG. 8 illustrates a block diagram showing the modules of a neural network device 800, in accordance with embodiments of the present disclosure. The neural network device 800 may be usable to perform embodiments of the methods described above. In some embodiments, the neural network device 800 may be connected to remote devices through network 810. The neural network device 800 may include a training data acquisition module 801. The training data acquisition module 801 may be used to obtain training data from the network 810. Such training data may include, for example, bundling information and other identification attribute information about previously-bundled software components. In some embodiments, training data acquisition module 801 may perform training data acquisition method 200 of FIG. 2. Information obtained by training data acquisition module 801 may be stored in database 802. The training data in the database 802 may, in turn, be used by training phase module 803 to train the applicable artificial neural network. In some embodiments, training phase module 803 may perform training phase method 400 of FIG. 4. The trained artificial neural network may then be used by execution phase module 804 to determine the bundle associated with an unbundled software component discovered on network 810 by new software component discovery module 805. In some embodiments, execution phase module 804 and new component discovery module 805 may together perform execution phase method 700 of FIG. 7. As shown, the results obtained from the execution phase module may be stored in database 802. In some embodiments, the results obtained may also be gathered by training data acquisition module 801 and may be used in future training of the artificial neural network.

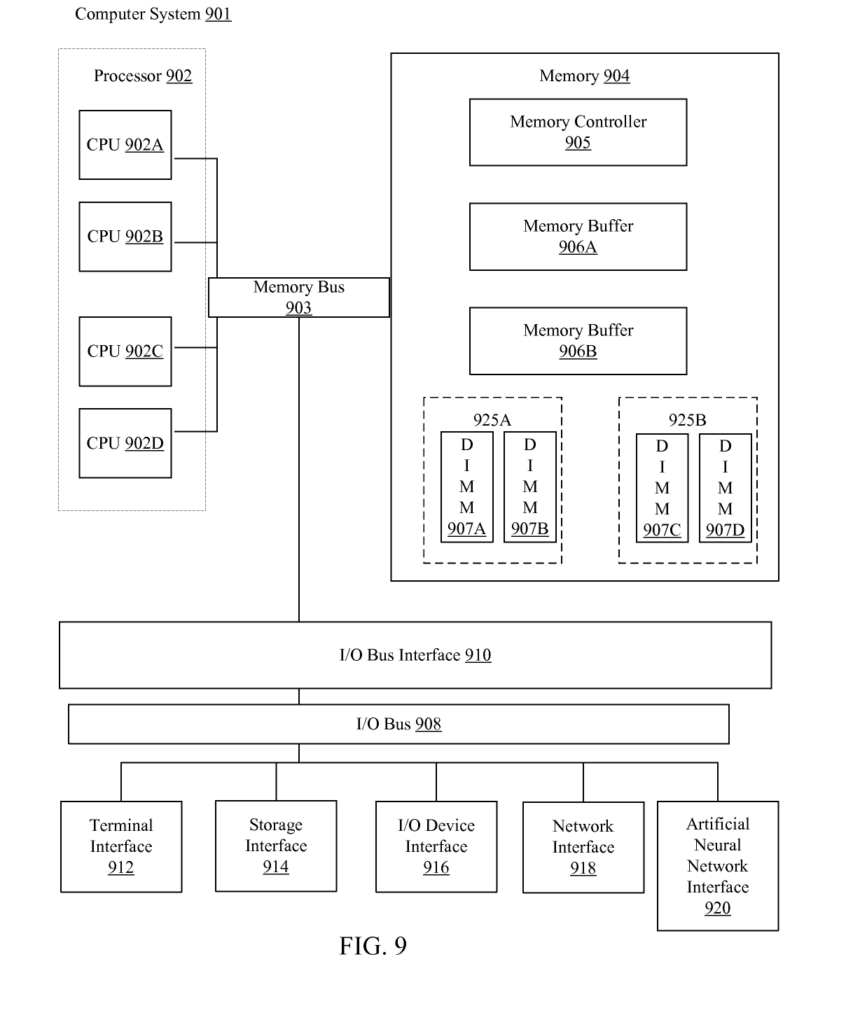

FIG. 9 depicts a high-level block diagram of an example computer system (i.e., computer) that may be used in implementing one or more embodiments of the invention. The mechanisms and apparatus of embodiments of the present invention may apply equally to appropriate computing systems disclosed herein. The major components of the computer system 901 comprise one or more CPUs 902, a memory subsystem 904, a terminal interface 912, a storage interface 914, an I/O (Input/Output) device interface 916, a network interface 918, and an artificial neural network interface 920, all of which are communicatively coupled, directly or indirectly, for inter-component communication via a memory bus 903, an I/O bus 908, and an I/O bus interface unit 910.

The computer system 901 may contain one or more general-purpose programmable central processing units (CPUs) 902A, 902B, 902C, and 902D, herein generically referred to as the CPU 902. In an embodiment, the computer system 901 may contain multiple processors typical of a relatively large system; however, in another embodiment the computer system 901 may alternatively be a single CPU system. Each CPU 902 executes instructions stored in the memory subsystem 904 and may comprise one or more levels of on-board cache.

In an embodiment, the memory subsystem 904 may comprise a random-access semiconductor memory, storage device, or storage medium (either volatile or non-volatile) for storing data and programs. In another embodiment, the memory subsystem 904 may represent the entire virtual memory of the computer system 901, and may also include the virtual memory of other computer systems coupled to the computer system 901 or connected via a network. The memory subsystem 904 may be conceptually a single monolithic entity, but in other embodiments the memory subsystem 904 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 904 may contain elements for control and flow of memory used by the CPU 902. This may include all or a portion of the following: a memory controller 905, one or more memory buffers 906A and 906B and one or more memory devices 925A and 925B. In the illustrated embodiment, the memory devices 925A and 925B may be dual in-line memory modules (DIMMs), which are a series of dynamic random-access memory (DRAM) chips 907A-907D (collectively referred to as 907) mounted on a printed circuit board and designed for use in personal computers, workstations, and servers. The use of DRAMs 907 in the illustration is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 904 in the computer system 901. In other embodiments the components may be arranged differently and have a variety of configurations. For example, the memory controller 905 may be on the CPU 902 side of the memory bus 903. In other embodiments, some or all of them may be on different computer systems and may be accessed remotely, e.g., via a network.

Although the memory bus 903 is shown in FIG. 9 as a single bus structure providing a direct communication path among the CPUs 902, the memory subsystem 904, and the I/O bus interface 910, the memory bus 903 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 910 and the I/O bus 908 are shown as single respective units, the computer system 901 may, in fact, contain multiple I/O bus interface units 910, multiple I/O buses 908, or both. While multiple I/O interface units are shown, which separate the I/O bus 908 from various communications paths running to the various I/O devices, in other embodiments some or all of the I/O devices are connected directly to one or more system I/O buses.

In various embodiments, the computer system 901 is a multi-user mainframe computer system, a single-user system, or a server computer or similar device that has little or no direct user interface, but receives requests from other computer systems (clients). In other embodiments, the computer system 901 is implemented as a desktop computer, portable computer, laptop or notebook computer, tablet computer, pocket computer, telephone, smart phone, network switches or routers, or any other appropriate type of electronic device.

FIG. 9 is intended to depict the representative major components of an exemplary computer system 901. But individual components may have greater complexity than represented in FIG. 9, components other than or in addition to those shown in FIG. 9 may be present, and the number, type, and configuration of such components may vary. Several particular examples of such complexities or additional variations are disclosed herein. The particular examples disclosed are for example only and are not necessarily the only such variations.

The memory buffers 906A and 906B, in this embodiment, may be intelligent memory buffers, each of which includes an exemplary type of logic module. Such logic modules may include hardware, firmware, or both for a variety of operations and tasks, examples of which include: data buffering, data splitting, and data routing. The logic module for memory buffers 906A and 906B may control the DIMMs 907A and 907B, the data flow between the DIMMs 907A and 907B and memory buffers 906A and 906B, and data flow with outside elements, such as the memory controller 905. Outside elements, such as the memory controller 905 may have their own logic modules that the logic modules of memory buffers 906A and 906B interact with. The logic modules may be used for failure detection and correcting techniques for failures that may occur in the DIMMs 907A and 907B. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffers 906A and 906B, memory controller 905, CPU 902, and even the DRAM 907 may use these techniques in the same or different forms. These logic modules may communicate failures and changes to memory usage to a hypervisor or operating system. The hypervisor or the operating system may be a system that is used to map memory in the system 901 and tracks the location of data in memory systems used by the CPU 902. In embodiments that combine or rearrange elements, aspects of the firmware, hardware, or logic modules capabilities may be combined or redistributed. These variations would be apparent to one skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-12. (canceled)

13. A system comprising:
an artificial neural network having an at least one input neuron and an at least one output neuron; and
one or more computer processor circuits that are configured to host a bundling application that is configured to:
identify a software component having a first value for a first identification attribute and a second value for a second identification attribute;
generate an input vector derived from the first value and the second value;
load the input vector into the at least one input neuron of the artificial neural network; and
obtain a yielded output vector from the at least one output neuron of the artificial neural network.

14. The system of claim 13, wherein the yielded output vector corresponds to a software bundle of a plurality of software bundles, and wherein the bundling application is further configured to:
determine, based on the yielded output vector, that the software component is associated with the software bundle.

15. The system of claim 13, wherein the software component is associated with a software bundle of a plurality of software bundles, and wherein the bundling application is further configured to:
generate a test output vector derived from the software bundle;
compare the yielded output vector with the test output vector; and
adjust parameters of the artificial neural network based on the comparison of the yielded output vector with the test output vector.

16. The system of claim 15, wherein the bundling application is further configured to:
identify a second software component having a third value for the first identification attribute and a fourth value for the second identification attribute;
generate a second input vector derived from the third value and the fourth value;
load the second input vector into the at least one input neuron of the artificial neural network;
obtain a second yielded output vector from the at least one output neuron of the artificial neural network, the second yielded output vector corresponding to a second software bundle of the plurality of software bundles; and
determine, based on the second yielded output vector, that the second software component is associated with the second software bundle.

17. A computer program comprising a computer readable storage medium having program instructions embodied therewith, the program instructions executable by a computer to cause the computer to:
identify a software component having a first value for a first identification attribute and a second value for a second identification attribute;
generate an input vector derived from the first value and the second value;
load the input vector into an at least one input neuron of an artificial neural network; and
obtain a yielded output vector from an at least one output neuron of the artificial neural network.

18. The computer program product of claim 17, wherein the yielded output vector corresponds to a software bundle of a plurality of software bundles, and wherein the program instructions are executable by the computer to further cause the computer to:
determine, based on the yielded output vector, that the software component is associated with the software bundle.

19. The computer program product of claim 17, wherein the software component is associated with a software bundle of a plurality of software bundles, and wherein the program instructions are executable by the computer to further cause the computer to:
generate a test output vector derived from the software bundle;
compare the yielded output vector with the test output vector; and
adjust parameters of the artificial neural network based on the comparison of the yielded output vector with the test output vector.

20. The computer program product of claim 19, wherein the program instructions are executable by the computer to further cause the computer to:
identify a second software component having a third value for the first identification attribute and a fourth value for the second identification attribute;
generate a second input vector derived from the third value and the fourth value;
load the second input vector into the at least one input neuron of the artificial neural network;
obtain a second yielded output vector from the at least one output neuron of the artificial neural network, the second yielded output vector corresponding to a second software bundle of the plurality of software bundles; and
determine, based on the second yielded output vector, that the second software component is associated with the second software bundle.
